(19) United States
(12) Patent Application Publication
(10) Pub. No.: US 2026/0241889 A1
(43) Pub. Date: Aug. 20, 2026

(54) Method and Device for Generating a Digital Access Key for a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/542,802

(22) Filed: Feb. 18, 2026

(30) Foreign Application Priority Data
Feb. 19, 2025 (DE) 10 2025 106 206.4

(51) Int. Cl. B60R 25/24; B60R 25/04; G07C 9/00; G07C 9/22; G07C 9/27; H04L 9/40

(52) U.S. Cl. CPC B60R 25/24; B60R 25/04; G07C 9/00309; G07C 9/00571; G07C 9/22; G07C 9/27; H04L 63/0442; B60R 2025/0415; G07C 2009/00412; G07C 2009/00531; G07C 2009/00793; G07C 2209/63

(57) ABSTRACT

A method and a device for generating a digital access key for a motor vehicle, wherein the method includes the following steps: providing key generation information for the motor vehicle from a remote vehicle management apparatus to a key management apparatus, the key generation information being encrypted; providing the encrypted key generation information from the key management apparatus to a user terminal; providing the encrypted key generation information from the user terminal to the motor vehicle; decrypting the encrypted key generation information in the motor vehicle; providing the decrypted key generation information from the motor vehicle to the user terminal; and generating the digital access key for the motor vehicle in the user terminal based on the decrypted key generation information.

### CROSS REFERENCE TO RELATED APPLICATION

This application claims priority under 35 U.S.C. § 119 from German Patent Application No. 10 2025 106 206.4, filed Feb. 19, 2025, the entire disclosure of which is herein expressly incorporated by reference.

### BACKGROUND AND SUMMARY

The invention relates to a method and a device for generating a digital access key for a motor vehicle.

There are solutions that make it possible to access and, in particular, unlock a motor vehicle using a so-called smart device. This is usually carried out after a digital access key has been configured on the smart device.

Document DE 10 2015 223 342 A1, for example, specifies a method for operating an authorization device for a vehicle, which authorization device is designed for initial communication with the vehicle and has a locating unit designed to determine a current location of the authorization device.

An object of the invention is to specify an improved method and an improved device for generating a digital access key for a motor vehicle.

This object is achieved in accordance with the invention by the subjects of the independent patent claims. The dependent patent claims and the description relate to advantageous embodiments of the invention.

A method according to the invention for generating a digital access key for a motor vehicle comprises the steps of providing key generation information for the motor vehicle from a remote vehicle management apparatus to a key management apparatus, the key generation information being encrypted; providing the encrypted key generation information from the key management apparatus to a user terminal; providing the encrypted key generation information from the user terminal to the motor vehicle; decrypting the encrypted key generation information in the motor vehicle; providing the decrypted key generation information from the motor vehicle to the user terminal; and generating the digital access key for the motor vehicle in the user terminal based on the decrypted key generation information.

The method is used in particular to generate data or information for generating one or more digital access keys for one or more motor vehicles in one or more user terminals, without sensitive information being readable by a key management apparatus operated, for example, by a fleet operator and/or end customers. In particular, the method is also used to generate one or more digital access keys for one or more motor vehicles in one or more user terminals, without contact with a remote vehicle management apparatus being necessary during generation, and with this generation also being able to take place offline, in particular.

A user terminal, which can also be referred to as a user unit, is a unit or a device designed to receive operator control inputs, user inputs and/or user commands and to communicate with a motor vehicle in order, in particular, to provide these operator control inputs to the motor vehicle and thereby trigger functions in the motor vehicle.

In particular, the user terminal is a portable or mobile unit which is different from the motor vehicle and which can be designed, in particular, as a so-called smart device, that is to say as a device having at least one processor apparatus, for example, a smartphone, a phablet or a tablet, a smart watch, smart glasses and/or a wearable, which also provides other functions, such as making calls, surfing the Internet or messaging services, for example, through applications or programs.

In particular, the user terminal is designed to trigger or perform one or more functions in relation to one or more motor vehicles, such as locking and/or unlocking one or more flaps, such as doors, and in particular also actively opening and/or closing one or more of such flaps, as well as releasing an immobilizer, starting an engine and/or moving the motor vehicle.

Such functions or interactions with the motor vehicle, in particular those enabling access or flap control and/or movement of the motor vehicle, can also be referred to as secure and/or protected functions and are supported in or by the user terminal or are implemented therein, in particular by means of a secure element, which can also be referred to as a secure module. Such a secure element may contain both hardware components, for example, in the form of a secure processor and/or a secure storage area, and software components, for example, one or more apps, applications or programs, which interact.

In order to trigger such functions, the user terminal typically has at least one digital access key. In particular, such a digital access key, which can also be referred to as a digital key, may be based on an asymmetric cryptosystem and/or may use such a system, in which case both the motor vehicle and the user terminal have a private key and a public key, which are designed to authorize or to legitimize one another. Such a digital access key is intended to be generated here for the user terminal, in particular for the first time.

For this purpose, in a first step, key generation information for the motor vehicle is provided from a remote vehicle management apparatus to a key management apparatus.

A remote vehicle management apparatus, which can also be referred to as a vehicle computing apparatus and/or a first computing apparatus, is different, separate and spaced apart from the motor vehicle and the user terminal. The remote vehicle management apparatus may include one or more servers which are also partially or completely organized in the cloud. The remote vehicle management apparatus can be operated, in particular, by a manufacturer and/or service provider of the motor vehicle and can be used, in particular exclusively, to generate and/or manage one or more digital access keys for one or more motor vehicles.

The key management apparatus, which can also be referred to as a local key computing apparatus or a second computing apparatus, can be embodied in particular as a personal computer and can be connected to one or more servers and/or comprise them. The key management apparatus is in particular referred to as local, since it is located locally close to the user terminal and, in particular, in contrast to the remote computing apparatus, can be approached by the user terminal.

The communication between the key management apparatus and the remote vehicle management apparatus can be carried out, in particular, via one or more wired and/or wireless communication protocols or standards, in particular far-field communication protocols, such as one or more of LAN, WLAN or WIFI and/or mobile radio, in particular 3G, 4G, 5G, etc.

The provision of the key generation information for the motor vehicle from the remote vehicle management apparatus to the key management apparatus may in particular be the first step of the method and in particular trigger the method. Alternatively, the provision of the key generation information may have been preceded by a creation request that triggers the method. This generation request can be triggered, for example, by a or the user of the user terminal in order to generate a, in particular the first, digital access key. Here and below, the term information is used synonymously in both the singular and the plural and comprises both an individual or single item of information and a plurality of items of information.

An item of key generation information is an item of information or a data item on the basis of which a digital access key for the motor vehicle can be generated, in particular for the first time. For example, the key generation information is verification, authorization and/or confirmation data that a generated key is correct, genuine and/or secure and/or includes these data or this information. In particular, the key generation information can be provided in the course of the method to the user terminal and a digital access key for the motor vehicle can be created or generated there by the user terminal, in particular using the motor vehicle, as will also be explained below.

The key generation information is encrypted. In particular, the key generation information is encrypted together with further information. The key generation information and, if necessary, further information can be compiled and also encrypted in particular beforehand, before carrying out the method or in response to the generation request, by the remote vehicle management apparatus.

In particular, the key management apparatus is not designed and/or configured to decrypt the encrypted key generation information. In particular, the key management apparatus does not have any information for decrypting the encrypted key generation information.

The encrypted key generation information is then provided from the key management apparatus to a user terminal. The communication between the key management apparatus and the user terminal can be carried out in particular via one or more wireless communication protocols or standards, in particular near-field communication protocols, such as one or more of Bluetooth, in particular Bluetooth LE, UWB, RFID and/or NFC.

The user terminal is also not designed and/or configured to decrypt the encrypted key generation information. In particular, the user terminal also does not have any information for decrypting the encrypted key generation information. In particular, the encrypted key generation information is/was not processed and/or changed in the user terminal, but is/was only buffered for further use.

The encrypted key generation information is then provided from the user terminal to the motor vehicle. The communication between the user terminal and the motor vehicle can in particular also be carried out via one or more wireless communication protocols or standards, in particular near-field communication protocols, such as one or more of Bluetooth, in particular Bluetooth LE, UWB, RFID and/or NFC.

The encrypted key generation information is then decrypted in the motor vehicle. The motor vehicle is designed and/or configured to decrypt the encrypted key generation information. In particular, in contrast to the user terminal and/or the key management apparatus, the motor vehicle has sufficient information for decrypting the encrypted key generation information.

In particular, the motor vehicle has, in particular as a single unit or apparatus, means, such as a key, for decrypting the encrypted key generation information. In particular, the motor vehicle and the remote vehicle management apparatus have already exchanged and/or mutually provided beforehand, in particular before carrying out the method, before providing the key generation information from the remote vehicle management apparatus to the key management apparatus and/or before encryption of the key generation information by the remote vehicle management apparatus, one or more keys, in particular a public key, for encrypting and/or decrypting the key generation information. In particular, one or more keys were exchanged and/or provided without the assistance and/or knowledge of the key management apparatus and/or the user terminal.

The decrypted key generation information is then provided from the motor vehicle to the user terminal. This can also be carried out as described above via one or more wireless communication protocols or standards, in particular near-field communication protocols, such as one or more of Bluetooth, in particular Bluetooth LE, UWB, RFID and/or NFC, in particular using the same communication protocol as that for providing the encrypted key generation information from the user terminal to the motor vehicle.

The digital access key for the motor vehicle is then generated or created in the user terminal based on the decrypted key generation information. In particular, a first, digital access key for the motor vehicle is finalized or learnt in the user terminal using the decrypted key generation information. For this purpose, it is also possible to use further information, in particular vehicle identification information, which has been provided in particular from the motor vehicle to the user terminal, for example together with the decrypted key generation information, or user terminal identification information, which has been provided in particular from the user terminal to the motor vehicle.

With the generated digital access key, one or more actions with respect to the motor vehicle, in particular functions, which were not possible before generation of the digital access key, can then be triggered by the user terminal.

The method according to the invention makes it possible to generate a digital access key for a motor vehicle without sensitive information being readable by a key management apparatus operated, for example, by a fleet operator and/or end customers. In particular, the method also makes it possible to generate a digital access key for a motor vehicle in a user terminal, without contact with a remote vehicle management apparatus being necessary during the generation, and with this generation also being able to take place offline, in particular.

According to one development, the method further comprises the step of unlocking the motor vehicle by means of the user terminal using the digital access key.

In particular, the motor vehicle is unlocked by the user terminal using the digital access key in response to the generation of the digital access key, in particular immediately and more particularly without a further user input on the user terminal. Alternatively or additionally, the unlocking can also be carried out at a later time and/or based on a user input on the user terminal.

Alternatively or additionally, the method further comprises the step of starting an ignition of the motor vehicle, starting an engine of the motor vehicle and/or releasing an immobilizer by means of the user terminal using the digital access key, in particular in response to the generation of the digital access key.

This development makes it possible to perform particularly safe functions with regard to the motor vehicle.

According to one development, the method further comprises the step of detecting when the user terminal approaches the key management apparatus, the step of providing the encrypted key generation information from the key management apparatus to the user terminal being carried out in response to the approach.

According to this development, it is detected when the user terminal approaches the key management apparatus. In the present case, an approach comprises, in particular, entering a range of a, in particular wireless, transceiver of the user terminal and/or the key management apparatus by unilateral or mutual approach. For example, the detected approach includes an approach of the user terminal or a transceiver included in the latter to less than 10 m, 5 m, 2 m, 1 m, 0.5 m, 0.2 m or 0.1 m from the key management apparatus or a transceiver included in the latter.

In response to the approach, communication information can then be exchanged first and then the encrypted key generation information later. The approach is detected in particular in response to or after providing the encrypted key generation information from the remote vehicle management apparatus to the key management apparatus.

This development makes it possible to exchange the key generation information in a particularly convenient manner.

According to one development, the user terminal approaches the key management apparatus for the first time.

In particular, the user terminal approaches for the first time after providing the encrypted key generation information from the remote vehicle management apparatus to the key management apparatus. In particular, no encrypted key generation information, in particular for the motor vehicle, has been previously provided from the key management apparatus to the user terminal. Alternatively or additionally, the encrypted key generation information is provided from the key management apparatus to the user terminal for the motor vehicle for the first time.

This development makes it possible to exchange the key generation information in a particularly convenient manner.

According to one development, the method further comprises the step of detecting when the user terminal approaches the motor vehicle, the step of providing the encrypted key generation information from the user terminal to the motor vehicle being carried out in response to the approach.

According to this development, it is detected when the user terminal approaches the motor vehicle. In the present case, an approach comprises, in particular, entering a range of a, in particular wireless, transceiver of the user terminal and/or the motor vehicle by unilateral or mutual approach. For example, the detected approach includes an approach of the user terminal or a transceiver included in the latter to less than 10 m, 5 m, 2 m, 1 m, 0.5 m, 0.2 m or 0.1 m from the motor vehicle or a transceiver included in the latter. Such a transceiver may be arranged in particular in one or more door handles, in particular a driver's door handle, of the motor vehicle.

In response to the approach, communication information can then be exchanged first and then the encrypted key generation information later.

This development makes it possible to exchange the key generation information in a particularly convenient manner.

According to one development, the method further comprises the step of detecting when the user terminal approaches the motor vehicle, the step of decrypting the encrypted key generation information being carried out in the motor vehicle in response to the approach.

According to this development, it is also detected when the user terminal approaches the motor vehicle. In the present case, an approach comprises, in particular, entering a range of a, in particular wireless, transceiver of the user terminal and/or the motor vehicle by unilateral or mutual approach. For example, the detected approach includes an approach of the user terminal or a transceiver included in the latter to less than 10 m, 5 m, 2 m, 1 m, 0.5 m, 0.2 m or 0.1 m from the motor vehicle or a transceiver included in the latter. Such a transceiver may be arranged in particular in one or more door handles, in particular a driver's door handle, of the motor vehicle.

In response to the approach, the previously provided encrypted key generation information can then be decrypted, as described above.

This development can take place as an alternative or in addition to the above-mentioned development. In particular, in response to the approach, the encrypted key generation information may be provided to the motor vehicle first and, in particular immediately thereafter or without removing the user terminal from the motor vehicle, the encrypted key generation information may be decrypted in the motor vehicle, or, separately therefrom in terms of time, or after the user terminal has been removed and approaches the motor vehicle again.

This development makes it possible to exchange the key generation information in a particularly convenient manner.

According to one development, the method further comprises the step of detecting when the user terminal approaches the motor vehicle, the step of providing the decrypted key generation information from the motor vehicle to the user terminal being carried out in response to the approach.

According to this development, it is also detected when the user terminal approaches the motor vehicle. In the present case, an approach comprises, in particular, entering a range of a, in particular wireless, transceiver of the user terminal and/or the motor vehicle by unilateral or mutual approach. For example, the detected approach includes an approach of the user terminal or a transceiver included in the latter to less than 10 m, 5 m, 2 m, 1 m, 0.5 m, 0.2 m or 0.1 m from the motor vehicle or a transceiver included in the latter. Such a transceiver may be arranged in particular in one or more door handles, in particular a driver's door handle, of the motor vehicle.

In response to the approach, communication information can then be exchanged first and then the decrypted key generation information later.

This development can take place as an alternative or in addition to the two above-mentioned developments. In particular, in response to the approach, the encrypted key generation information may be provided to the motor vehicle first and, in particular immediately thereafter or without removing the user terminal from the motor vehicle, the encrypted key generation information may be decrypted in the motor vehicle, and in particular immediately thereafter again, the decrypted key generation information may be provided from the motor vehicle to the user terminal, or, separately therefrom in terms of time, or after the user terminal has been removed and approaches the motor vehicle again one or more times.

This development makes it possible to exchange the key generation information in a particularly convenient manner.

According to one development, the user terminal approaches the motor vehicle for the first time.

In particular, the user terminal approaches for the first time after providing the encrypted key generation information from the key management apparatus to the user terminal. In particular, no encrypted and/or decrypted key generation information has previously been exchanged between the user terminal and the motor vehicle. Alternatively or additionally, the encrypted key generation information is provided from the user terminal to the motor vehicle for the first time and/or the encrypted key generation information is decrypted for the first time and/or the decrypted key generation information is provided from the motor vehicle to the user terminal for the first time.

This development makes it possible to exchange the key generation information in a particularly convenient manner.

According to one development, the key generation information comprises immobilization information, wherein the step of generating the digital access key for the motor vehicle in the user terminal comprises providing the immobilization information from the motor vehicle to the user terminal.

Immobilization information, which can also be referred to as an immobilization token or immotoken, is an item of information or a data item that can be used, in particular exclusively, to release an immobilizer of the motor vehicle. This immobilization information is included in the key generation information or the immobilization information represents the, in particular only, key generation information. The immobilization information may have been encrypted, in particular together with the key generation information, by the remote vehicle management apparatus and may have been decrypted by the motor vehicle.

Additionally or alternatively, the key generation information may also include further data and/or information, in particular those/that which is/are secret and/or not public. These include, for example, one or more keys, in particular one or more symmetric keys, such as those for a symmetric cryptosystem, which exists or is set up in particular between the motor vehicle and the user terminal, and/or one or more tokens. These further data and/or this further information can then also be provided from the motor vehicle to the user terminal in the step of generating the digital access key for the motor vehicle in the user terminal.

This development makes it possible to perform particularly safe functions with regard to the motor vehicle.

According to one development, the step of providing the immobilization information comprises providing the immobilization information from the motor vehicle to a secret storage area of the user terminal.

For this purpose, the user terminal has in particular at least two different storage areas, one of which, a secret area, has higher security requirements, in particular with regard to access, such as write and/or read rights, than a further, less secure area. The secret storage area is managed in particular by the secure element, in particular exclusively, and in particular cannot be accessed by other elements, in particular other applications or software elements.

In particular, the user terminal has at least three storage areas, which have different or differently high security requirements. For example, the secure element, in particular exclusively, has access to a secret area, a private area and an insecure area, which can also be referred to as a public area. At least the secret area and the private area, and optionally also the insecure area, to which the secure element has access, can also be referred to as a mailbox.

In particular, only the secure element itself and/or one or more motor vehicles, in particular the motor vehicle, is/are entitled to obtain access to the secret storage area and, in particular, to exercise write access to it. Thus, the immobilization information is written to or at least effected in the secret storage area of the user terminal by the motor vehicle.

This development makes it possible to perform particularly safe functions with regard to the motor vehicle.

According to another aspect, a device for generating a digital access key for a motor vehicle is specified.

The device comprises means for carrying out one or more embodiments of the method described above. In particular, the device comprises one or more processor apparatus to carry out the method described above. In particular, the device also comprises a memory in which code is stored, in particular in a non-volatile manner, which, when executed by a processor apparatus, causes this to carry out the method described above.

In particular, the device may comprise a user terminal, one or more remote or local computing apparatus, in particular a remote vehicle management apparatus and/or a local key management apparatus, or may form a system therewith in order to perform or at least effect the method described above. The device may also comprise one or more motor vehicles and/or a motor vehicle fleet comprising a plurality of motor vehicles or may form a system therewith. In particular, the device may comprise any apparatus and/or any unit as described above or may form a system therewith.

Further features of the invention emerge from the claims, the figures and the description of the figures. The features and combinations of features mentioned above in the description, and the features and combinations of features mentioned below in the description of the figures and/or shown in the figures alone can be used not only in the respectively specified combination but also in other combinations or on their own.

The invention will now be explained in more detail on the basis of one preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of one embodiment of a method and a device for generating a digital access key for a motor vehicle;

FIG. 2 shows a schematic flowchart of one embodiment of a method for generating a digital access key for a motor vehicle;

FIG. 3 shows a schematic flowchart of a further embodiment of a method for generating a digital access key for a motor vehicle; and

FIG. 4 shows a schematic flowchart of a further embodiment of a method for generating a digital access key for a motor vehicle.

### DETAILED DESCRIPTION OF THE DRAWINGS

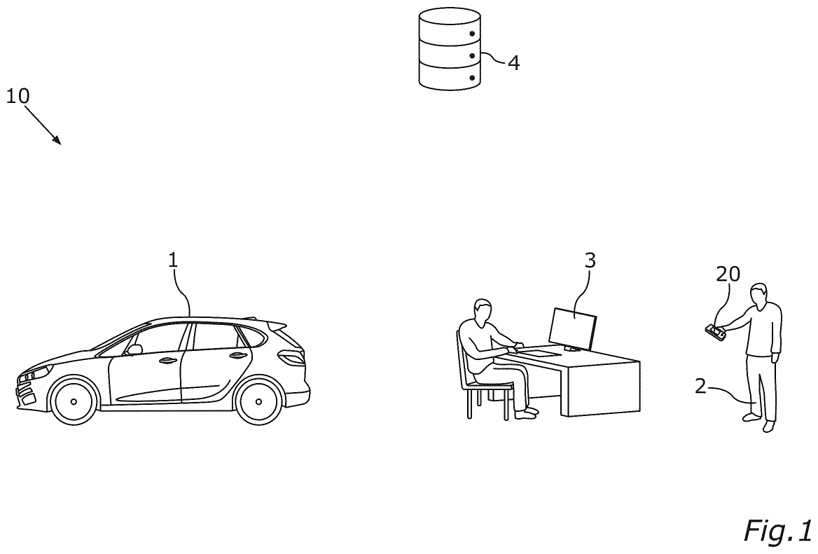

FIG. 1 shows a schematic perspective view of one embodiment of a method and a device 10 for generating a digital access key for a motor vehicle 1.

The device 10 comprises the user terminal 20 of a user 2, a remote vehicle computing apparatus 4 and a local key management apparatus 3. The device 10 is designed to perform or at least effect the method steps described below.

The device 10 is designed to provide key generation information for the motor vehicle 1 from the remote vehicle management apparatus 4 to a key management apparatus 3, the key generation information being encrypted and comprising immobilization information which is also encrypted.

The device 10 is also designed to detect when the user terminal 20 approaches the key management apparatus 3 for the first time.

The device 10 is also designed to provide the encrypted key generation information from the key management apparatus 3 to the user terminal 20 for the first time in response to the approach.

The device 10 is also designed to detect when the user terminal 20 approaches the motor vehicle 1 for the first time.

The device 10 is also designed to provide the encrypted key generation information from the user terminal 20 to the motor vehicle 1 for the first time in response to the approach.

The device 10 is also designed to decrypt the encrypted key generation information in the motor vehicle 1 for the first time in response to the approach.

The device 10 is also designed to provide the decrypted key generation information from the motor vehicle 1 to the user terminal 20 for the first time in response to the approach.

The device 10 is also designed to generate the digital access key for the motor vehicle 1 in the user terminal 20 based on the decrypted key generation information.

The device 10 is also designed to provide the immobilization information from the motor vehicle 1 to a secret storage area of the user terminal 20.

The device 10 is also designed to unlock the motor vehicle 1 by means of the user terminal 20 using the digital access key.

The device 10 is also designed to release an immobilizer of the motor vehicle 1 by means of the user terminal 20 using the digital access key and to start the motor vehicle 1.

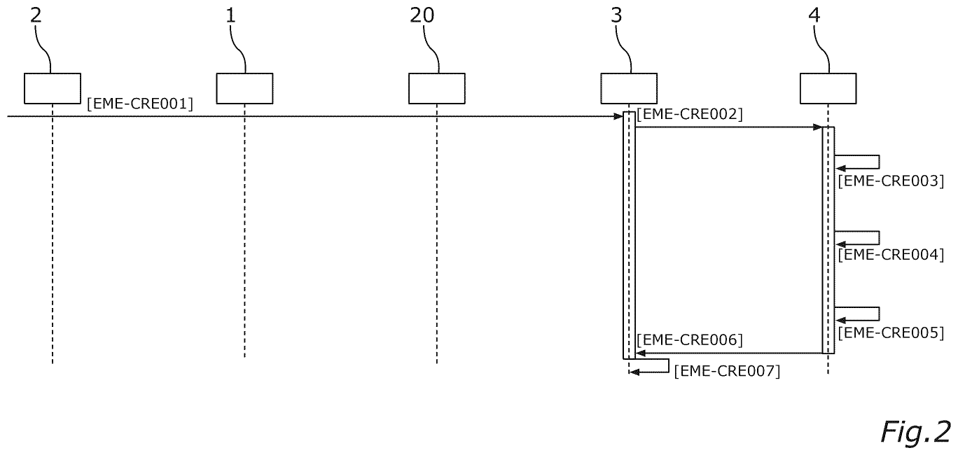

FIG. 2 shows a schematic flowchart of one embodiment of a method for generating a digital access key for the motor vehicle 1 from FIG. 1.

These steps concern in particular the generation and compilation of key generation information, and in particular of motor vehicle confirmation data, which are needed or used to generate a digital access key for the motor vehicle 1, and take place in response to an external event, in particular between the key management apparatus 3 and the remote vehicle management apparatus 4.

In a first method step EME-CRE-001 of this method section shown here, a request to update or create for the first time motor vehicle confirmation data, which can also be referred to as an attestation or attestation data, for the motor vehicle 1 is provided to the key management apparatus 3 as a result of an external event. These motor vehicle confirmation data are based in particular on data that are stored or are present in the remote vehicle management apparatus 4. The triggering external event can either come from the user 2 himself, for example by virtue of a user input or request, or can be alternatively triggered regularly or periodically.

In a further method step EME-CRE-002, a request to generate or update the motor vehicle confirmation data for the motor vehicle 1 in the remote vehicle management apparatus 4 and to provide them to the key management apparatus 3 is provided from the key management apparatus 3 to the remote vehicle management apparatus 4.

In a further method step EME-CRE-003, a check is carried out in the remote vehicle management apparatus 4 in order to determine whether the request from the key management apparatus 3 is permissible and verifies this.

In a further method step EME-CRE-004, the motor vehicle confirmation data are compiled in the remote vehicle management apparatus 4. These include, in particular, vehicle identification information, metadata for an access key for the motor vehicle 1 and, in particular, encrypted information for a secret storage area of the user terminal, which also comprise (encrypted) immobilization information and optionally further secret data, such as one or more keys for a symmetric cryptosystem and/or one or more tokens.

These motor vehicle confirmation data also include a signature which itself includes or signs the confirmation data. The encrypted information, in particular the encrypted immobilization information, is the key generation information and cannot be decrypted by the user terminal 20 and/or the key management apparatus 3, but rather in particular exclusively by the motor vehicle 1, in particular because the motor vehicle 1 was provided with the necessary information. In particular, before carrying out the present method, decryption information for this encrypted information, in particular the encrypted immobilization information, was already provided beforehand to the motor vehicle 1 from the remote vehicle management apparatus 4 and/or encryption information was already provided beforehand from the motor vehicle 1 to the remote vehicle management apparatus 4. For example, the motor vehicle 1 and the remote vehicle management apparatus 4 have previously exchanged or provided each other with a key pair, for example, consisting of a public and a private key.

In a further method step EME-CRE-005, key management information is updated in the remote vehicle management apparatus 4, in particular in order to maintain or reserve a storage space for a new access key for the motor vehicle 1 to be generated by the method described here based on the key generation information.

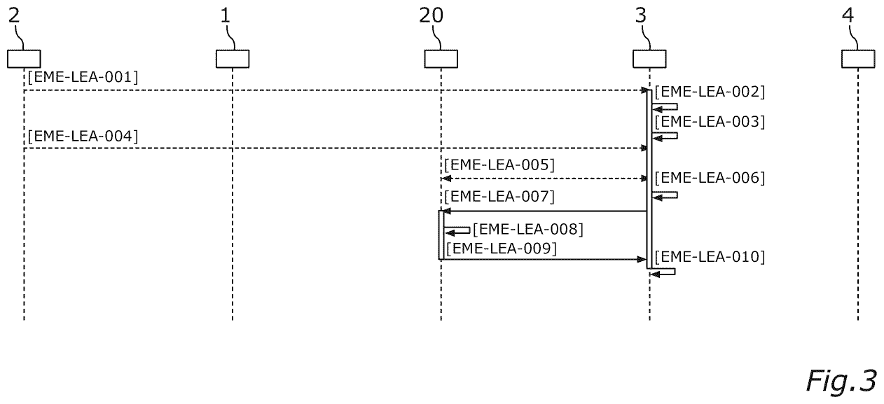

In a further method step EME-CRE-006, the previously compiled motor vehicle confirmation data comprising the encrypted key generation information and the further, in particular secret data are provided from the remote vehicle management apparatus 4 to the key management apparatus 3 and, in a further, final method step EME-CRE-007 of this method section shown here, the obtained motor vehicle confirmation data comprising the encrypted key generation information and the further, in particular secret data are saved or stored for further use in the key management apparatus 3, as will be explained in connection with the following FIG. 3.

In particular, by virtue of this method section shown here in this FIG. 2, the key generation information comprising the motor vehicle confirmation data, which are managed in the remote vehicle management apparatus 4, are compiled and provided to the key management apparatus 3 for further use, in particular without further interaction by the remote vehicle management apparatus 4 with a user terminal 20, the motor vehicle 1 or a user 2. The key management apparatus 3 is, however, in particular not designed to decrypt the key generation information and in particular the encrypted immobilization information.

FIG. 3 shows a schematic flowchart of one embodiment of a method for generating a digital access key for the motor vehicle 1 from FIG. 1.

The method steps described here in connection with this FIG. 3 relate in particular to the actual generation of the digital access key for the motor vehicle 1 based on the encrypted key generation information and can also be referred to as learning a digital access key. These steps take place in particular between the user 2, the key management apparatus 3 and the user terminal 20 and are carried out in particular without further interaction or communication with the motor vehicle 1 and/or the remote vehicle management apparatus 4. In particular, the user terminal 20 does not communicate with the remote vehicle management apparatus 4 and/or the motor vehicle 1 in the further course of the method section shown here in FIG. 3.

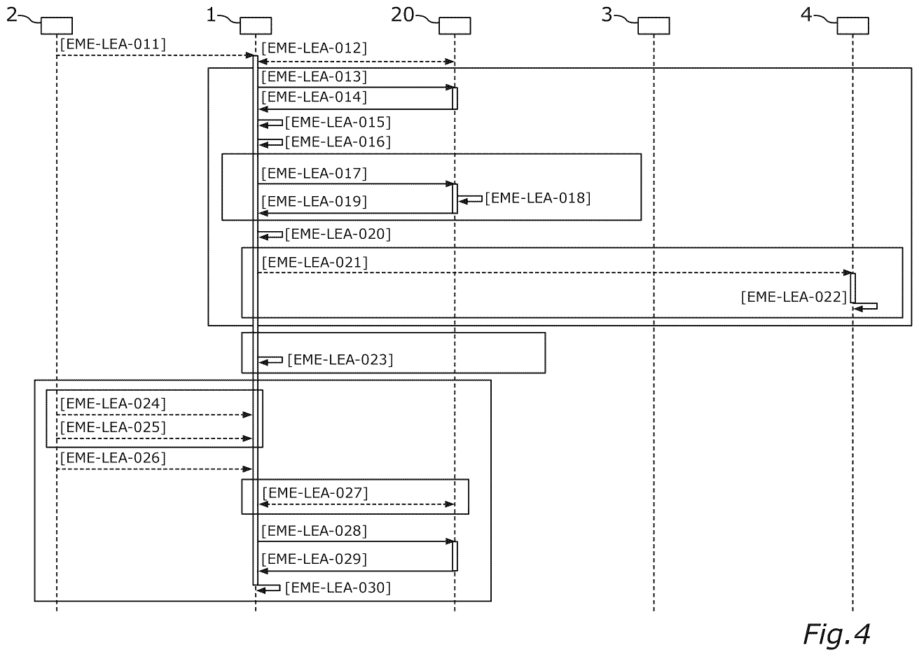

However, this does not preclude prior or subsequent communication, in particular between the motor vehicle 1 and the remote vehicle management apparatus 4. For example, in particular, the motor vehicle 1 of the remote vehicle management apparatus 4 may communicate or provide the generation or finalization and/or a change of a status or state of the digital access key for the motor vehicle 1 to the user terminal 20 in the further course of the method, as will be explained below in connection with FIG. 4.

In particular, the method section shown in connection with this FIG. 3 follows the method section from FIG. 2 or was run through at least once before carrying out the method section from FIG. 2.

In a first method step EME-LEA-001 of this method section shown here, a request to generate at least one digital access key for the motor vehicle 1 is provided by the user 2 to the key management apparatus 3 and is received there.

In a further method step EME-LEA-002, further key generation information is compiled in response to the user request. This includes, in particular, certificate information, such as endpoint identification information, and vehicle identification information. In particular, this further key generation information comprises further data and/or information needed to generate or finalize a digital access key for the motor vehicle 1.

In a further method step EME-LEA-003, the user 2 is requested to bring the user terminal into the vicinity of the key management apparatus 3 or to bring it closer, in particular to bring it in within range of a wireless transceiver of the key management apparatus 3. This request is output in particular at the key management apparatus 3, for example, on a display apparatus.

In a further method step EME-LEA-004, the user terminal 20 is brought into the vicinity of the key management apparatus 3 or is brought closer to it, in particular is brought within range of a wireless transceiver of the key management apparatus 3, by the user 2 in response to the previously issued request.

In a further method step EME-LEA-005, the user terminal 20 is learnt in the key management apparatus 3, for which purpose in particular data are exchanged between the user terminal 20 and the key management apparatus 3. These data include, inter alia, the previously compiled key generation information comprising the endpoint identification information, and the vehicle identification information. In particular, a secret key of an endpoint certificate is generated in or for the user terminal 20 by this or by the following steps and can then be stored in a secure element of the user terminal 20.

In a further method step EME-LEA-006, further key generation information is compiled. In the present case, this comprises key management confirmation data from the key management apparatus 3 and contains in particular information regarding rights and privileges of the user terminal 20, one or more keys, such as a public key based on the endpoint identification information, and in particular also the key generation information previously received from the remote vehicle management apparatus 4 and comprising the motor vehicle confirmation data with the vehicle identification information, metadata for an access key for the motor vehicle 1 and, in particular, the encrypted information for a secret storage area of the user terminal, which also comprises the encrypted immobilization information.

In a further method step EME-LEA-007, the previously compiled key generation information with the encrypted immobilization information and the further, in particular secret data are provided to the user terminal 20 and are written there into a secure element and in particular a private storage section of the user terminal 20.

In a further method step EME-LEA-008, these previously received key management confirmation data are persisted, i.e., stored in a non-volatile manner, in the user terminal 20 in a private storage section, as described above.

In a further method step EME-LEA-009, in response to the persistence, a success notification is provided to the key management apparatus 3 which in return in a further method step EME-LEA-010 provides user information to the user 2 stating that the user terminal 20 has been legitimized for key generation. This can also be carried out on a display apparatus. In particular, the user terminal is not designed to decrypt the key generation information and in particular the encrypted immobilization information.

FIG. 4 shows a schematic flowchart of one embodiment of a method for generating a digital access key for the motor vehicle 1 from FIG. 1.

The method steps described here in connection with this FIG. 4 relate in particular to the actual application of the digital access key for the motor vehicle 1. These steps take place in particular between the user 2, the user terminal 20, the remote vehicle management apparatus 4 and the motor vehicle 1 and are carried out in particular without further interaction or communication with the key management apparatus 3. In particular, neither the motor vehicle 1 nor the user terminal 20 nor the remote vehicle management apparatus 4 communicates with the key management apparatus 3 in the further course of the method section shown here in FIG. 4.

In particular, the method section shown in connection with this FIG. 4 follows the method section from FIG. 3 or was run through at least once before carrying out the method section from FIG. 3.

In a first method step EME-LEA-011 of this method section shown here in FIG. 4, the user terminal 20 is brought by the user 2 into the vicinity of the motor vehicle 1 or brought closer to it, in particular within range of a wireless, in particular first, transceiver of the motor vehicle 1, which may be located in particular on the outside of the motor vehicle, for example, in and/or on a door, in particular a driver's door, more particularly in a door handle.

In a further method step EME-LEA-012, data are then exchanged between the motor vehicle 1 and the user terminal 20 in order, in particular first, to unlock the motor vehicle 1, as described further below in connection with step EME-LEA-023, and/or in order, in particular gradually, to cause an engine start, as described in connection with step EME-LEA-030. This data exchange can also be referred to in particular as standard exchange or a standard transaction. In particular, in the context of data exchange using a secure communication channel, key generation data and in particular the key management confirmation data are exchanged between the motor vehicle 1 and the user terminal 20, as will also be explained below. This step EME-LEA-012 is carried out in particular for each approach, i.e., even if the digital access key has already been generated and/or stored in the user terminal 20 and in particular the digital access key of the user terminal 20 is already known to the motor vehicle 1, for example, because it has already previously been used to unlock the motor vehicle 1 using the digital access key.

If the user terminal 20 is or was not yet known to the motor vehicle 1 and/or was brought for the first time into the vicinity of the motor vehicle 1, in particular exclusively then, steps EME-LEA-013 to EME-LEA-022 described below are carried out. In particular, by virtue of the following steps, the digital access key based on the key generation information, which is already available to the user terminal 20 as a result of the previous communication, is made known or taught to the motor vehicle 1.

In a further method step EME-LEA-013, the key generation information comprising the key management confirmation data and in particular the encrypted immobilization information is queried or requested from the user terminal 20 by the motor vehicle 1 and in response to this, in a further method step EME-LEA-014, this key generation information is provided from the user terminal 20 to the motor vehicle 1.

In a further method step EME-LEA-015, these received key management confirmation data and in particular the signatures included therein are verified in the motor vehicle 1.

If the verification was successful, secret information comprising in particular the encrypted immobilization information is decrypted from the key generation information in a further method step EME-LEA-016.

The further steps EME-LEA-017 to EME-LEA-019 relate in particular to finalization of the key generation. This is carried out in particular by virtue of the fact that the motor vehicle 1, in particular exclusively, can access the secret storage area of the user terminal 20, in particular in the form of write access, as explained below.

In a further method step EME-LEA-017, this immobilization information previously decrypted in the motor vehicle 1 is then provided to the user terminal 20 and written to a secret storage area there. This secret storage area is configured in particular in such a way that it can be written to exclusively by the motor vehicle 1.

In a further method step EME-LEA-018, this decrypted immobilization information is then persisted in the secret storage area and, in a further method step EME-LEA-019, the successful write access to the secret storage area or the persistence is provided to the motor vehicle 1.

In a further method step EME-LEA-020, the generated digital access key is then also persisted in the motor vehicle 1.

In a further method step EME-LEA-021, the generation and the finalization and in particular the persistence of the digital access key in the motor vehicle 1 are provided to the remote vehicle management apparatus 4 or the remote vehicle management apparatus 4 is informed thereof and, in a further method step EME-LEA-022, key management information, In particular in the form of a table, is updated, in particular with the previously generated, finalized and/or persisted digital access key.

In a further method step EME-LEA-023, the motor vehicle 1 can then be unlocked. This can also be carried out in particular if there is no immobilization information available in the user terminal, but only a valid signature of the confirmation information, as described in connection with step EME-LEA-015, and/or the immobilization information is not verified for unlocking.

Steps EME-LEA-024 to EME-LEA-030 described below are then performed in order to start an ignition of the motor vehicle or to cause an engine start using the digital access key generated.

For this purpose, in a method step EME-LEA-024, the user 2 with the user terminal 20 enters the motor vehicle 1 and in particular an interior of the motor vehicle 1.

In a further method step EME-LEA-025, the user terminal 20 is brought by the user 2 into the vicinity, in particular within range, of a wireless, in particular second, transceiver of the motor vehicle 1 which is different from the first transceiver and may be located in particular in the interior of the motor vehicle 1, for example, in and/or on a center console and/or a dashboard.

In a further method step EME-LEA-026, a user input from the user 2 is received in the motor vehicle 1 in order to activate or carry out an ignition or an engine start of the motor vehicle 1. This function requires in particular the presence or provision of immobilization information for the user terminal 20.

For this purpose, in a further method step EME-LEA-027, an exchange of data, in particular a previously described standard transaction, is carried out again.

In a further method step EME-LEA-028, the immobilization information is requested from the user terminal 20 from the secret storage area and, in a further method step EME-LEA-029, this immobilization information is provided from the user terminal 20 to the motor vehicle 1.

In a final method step EME-LEA-030 of this method section shown here, the ignition and/or the engine of the motor vehicle 1 is/are started.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle
2 User
20 User terminal
3 Key management apparatus
4 Remote vehicle management apparatus
10 Device
EME-CRE-001 Method step
EME-CRE-002 Method step
EME-CRE-003 Method step
EME-CRE-004 Method step
EME-CRE-005 Method step
EME-CRE-006 Method step
EME-CRE-007 Method step
EME-LEA-001 Method step
EME-LEA-002 Method step
EME-LEA-003 Method step
EME-LEA-004 Method step
EME-LEA-005 Method step
EME-LEA-006 Method step
EME-LEA-007 Method step
EME-LEA-008 Method step
EME-LEA-009 Method step
EME-LEA-010 Method step
EME-LEA-011 Method step
EME-LEA-012 Method step
EME-LEA-013 Method step
EME-LEA-014 Method step
EME-LEA-015 Method step
EME-LEA-016 Method step
EME-LEA-017 Method step
EME-LEA-018 Method step
EME-LEA-019 Method step
EME-LEA-020 Method step
EME-LEA-021 Method step
EME-LEA-022 Method step
EME-LEA-023 Method step
EME-LEA-024 Method step
EME-LEA-025 Method step
EME-LEA-026 Method step
EME-LEA-027 Method step
EME-LEA-028 Method step
EME-LEA-029 Method step
EME-LEA-030 Method step

What is claimed is:

1. A method for generating a digital access key for a motor vehicle, the method comprising:
providing key generation information for the motor vehicle from a remote vehicle management apparatus to a key management apparatus, the key generation information being encrypted;
providing the encrypted key generation information from the key management apparatus to a user terminal;
providing the encrypted key generation information from the user terminal to the motor vehicle;
decrypting the encrypted key generation information in the motor vehicle;
providing the decrypted key generation information from the motor vehicle to the user terminal; and
generating the digital access key for the motor vehicle in the user terminal based on the decrypted key generation information.

2. The method according to claim 1, further comprising:
unlocking the motor vehicle by the user terminal using the digital access key.

3. The method according to claim 1, further comprising:
detecting when the user terminal approaches the key management apparatus;
wherein the encrypted key generation information is provided from the key management apparatus to the user terminal in response to an approach.

4. The method according to claim 2, further comprising:
detecting when the user terminal approaches the key management apparatus;
wherein the encrypted key generation information is provided from the key management apparatus to the user terminal in response to an approach.

5. The method according to claim 3, wherein the user terminal approaches the key management apparatus for a first time.

6. The method according to claim 1, further comprising:
detecting when the user terminal approaches the motor vehicle;
wherein the encrypted key generation information is provided from the user terminal to the motor vehicle in response to an approach.

7. The method according to claim 2, further comprising:
detecting when the user terminal approaches the motor vehicle;
wherein the encrypted key generation information is provided from the user terminal to the motor vehicle in response to an approach.

8. The method according to claim 1, further comprising:
detecting when the user terminal approaches the motor vehicle;
wherein the encrypted key generation information is decrypted in the motor vehicle in response to an approach.

9. The method according to claim 2, further comprising:
detecting when the user terminal approaches the motor vehicle;
wherein the encrypted key generation information is decrypted in the motor vehicle in response to an approach.

10. The method according to claim 1, further comprising:
detecting when the user terminal approaches the motor vehicle;
wherein the decrypted key generation information is provided from the motor vehicle to the user terminal in response to an approach.

11. The method according to claim 2, further comprising:
detecting when the user terminal approaches the motor vehicle;
wherein the decrypted key generation information is provided from the motor vehicle to the user terminal in response to an approach.

12. The method according to claim 6, wherein the user terminal approaches the motor vehicle for the first time.

13. The method according to claim 8, wherein the user terminal approaches the motor vehicle for the first time.

14. The method according to claim 10, wherein the user terminal approaches the motor vehicle for the first time.

15. The method according to claim 1, wherein the key generation information comprises immobilization information, and the generation of the digital access key for the motor vehicle in the user terminal comprises providing the immobilization information from the motor vehicle to the user terminal.

16. The method according to claim 2, wherein the key generation information comprises immobilization information, and the generation of the digital access key for the motor vehicle in the user terminal comprises providing the immobilization information from the motor vehicle to the user terminal.

17. The method according to claim 3, wherein the key generation information comprises immobilization information, and the generation of the digital access key for the motor vehicle in the user terminal comprises providing the immobilization information from the motor vehicle to the user terminal.

18. The method according to claim 15, wherein provision of the immobilization information comprises providing the immobilization information from the motor vehicle to a secret storage area of the user terminal.

19. The method according to claim 16, wherein provision of the immobilization information comprises providing the immobilization information from the motor vehicle to a secret storage area of the user terminal.

20. An apparatus for generating a digital access key for a motor vehicle, wherein the apparatus is configured to carry out a method according to claim 1.
